(19) United States
(12) Patent Application Publication
(10) Pub. No.: US 2015/0158596 A1
(43) Pub. Date: Jun. 11, 2015

(54) ONBOARD INERT GAS GENERATION SYSTEM

(71) Applicant: Eaton Limited, Titchfield Hampshire (GB)

(72) Inventor: Alan Ernest Massey, Locksheath (GB)

(21) Appl. No.: 14/561,223

(22) Filed: Dec. 5, 2014

(30) Foreign Application Priority Data
Dec. 6, 2013 (GB) 1321614.8

(51) Int. Cl. B64D 37/32

(52) U.S. Cl. CPC B64D 37/32

(57) ABSTRACT

An onboard inert gas generation system for an aircraft includes a compressor configured to receive cabin waste air and to supply compressed air directly to an air separation module such that the compressed air passes from the compressor to the air separation module without active cooling. The air separation module is configured to separate the air into a nitrogen-enriched air fraction and an oxygen-enriched air fraction.

### CROSS-REFERENCE TO PRIOR APPLICATION

Priority is claimed to British Patent Application No. GB 1321614.8, filed on Dec. 6, 2013, the entire disclosure of which is hereby incorporated by reference herein.

### FIELD

This invention relates to apparatus and method for the onboard generation of inert gas on an aircraft to facilitate inerting of the fuel tanks and other areas on board the aircraft.

### BACKGROUND

In this specification the widely accepted terminology is employed with the term “inert gas generation” meaning the generation of an oxygen depleted or “nitrogen-enriched atmosphere” (NEA). It is well-known to use one or more filters or “air separation modules” (ASMs) which separate a supply of inlet air into a nitrogen-enriched air portion (NEA) and an oxygen-enriched portion (OEA).

Current fuel tank inerting systems which include centrifugal compressors to boost cabin air typically require post-compression heat exchangers to reduce the compressed air to a temperature of 71° C. (160° F.) for supply to an air separation module. This scheme requires a ram-air cooling system comprising a NACA intake, ducting, a fan, a temperature control valve, a heat exchanger and an outlet to discharge the cooling air. A typical fuel tank inerting system architecture using cabin air as an air source is shown in FIG. 1 of the accompanying drawings. This shows a two-stage compressor comprising two compressors with intercooling, and a post-compression heat exchanger which cools the air supply to the air separation module to below about 71° C. Both the intercooler and the heat exchanger typically require a ram-air cooling circuit comprising a NACA intake, ducting, a temperature sensor and an outlet for discharging the cooling air. The weight of the equipment and the volume required to contain it, along with the multiple hull penetrations, place severe constraints on the aircraft designer. Furthermore, these above factors militate against retro-fitting such equipment to an existing aircraft.

ASM technology has evolved by the use of redesigning the flow paths of the incoming air and the NEA fraction, and also using high temperature fibres and resins for the components making up the air separation module, so that air separation modules capable of filtering air with an inlet temperature of up to about 150° C. (300° F.) are available.

### SUMMARY

In an embodiment, the present invention provides an onboard inert gas generation system for an aircraft. A compressor is configured to receive cabin waste air and to supply compressed air directly to an air separation module such that the compressed air passes from the compressor to the air separation module without active cooling. The air separation module is configured to separate the air into a nitrogen-enriched air fraction and an oxygen-enriched air fraction.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a block diagram of a prior art arrangement of an aircraft fuel tank inerting system, and

FIG. 2 is a block diagram of an aircraft fuel tank inerting system in accordance with an embodiment of the invention.

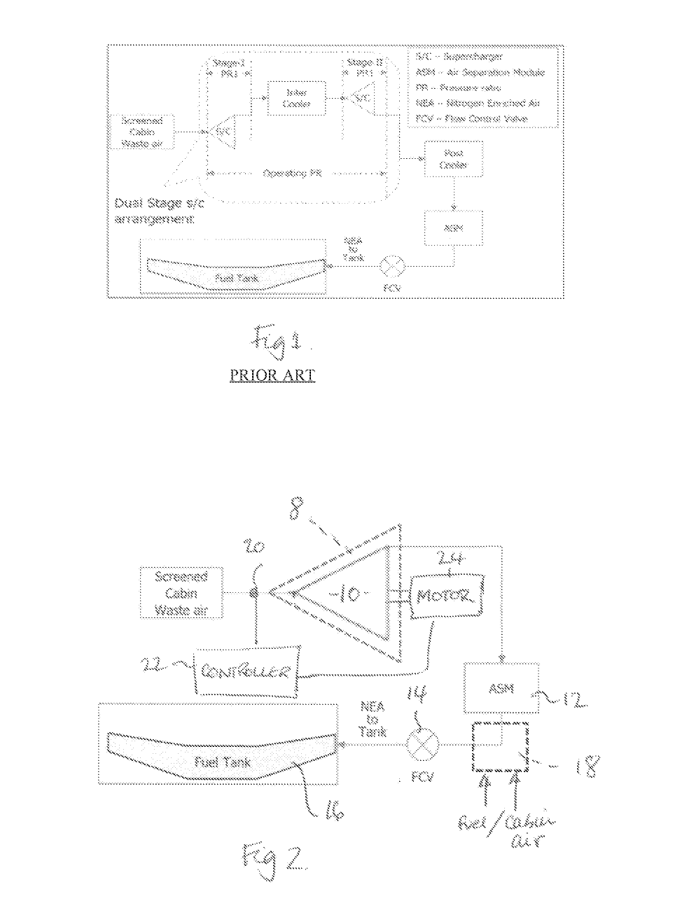

### DETAILED DESCRIPTION

The inventors have discovered that it is possible to provide a greatly simplified system for the generation of inert gas which receives cabin air, compresses it via a single stage compressor and then supplies it to an ASM without requiring the other second stage compressor, the inter-cooler and the post-compression heat exchanger and their respective cooling circuits of the conventional arrangement. The system therefore operates at higher temperature but at lower pressures than previously used. The higher operating temperature enhances the performance of the air separation module which compensates for the lower operating pressure so that previous separation performance is maintained.

Accordingly, in one embodiment, the present invention provides an onboard inert gas generation system for an aircraft, comprising a compressor configured to receive cabin waste air and to supply compressed air to an air separation module configured to separate the air into a nitrogen-enriched air fraction and an oxygen-enriched air fraction, with the compressed air passing from the compressor to the air separation module directly, without active cooling.

The term “without active cooling” is used to mean that the flow downstream of the compressor to the air separation module does not pass through a heat exchanger requiring provision of a secondary, cooling flow, from an external source. However it does not preclude the possibility of cooling the compressor itself, for example by means of cooling fins, the external passage of a coolant fluid such as a further portion of cabin air, or a mixture of these features.

In this arrangement, the second stage compressor, the inter-cooler and the post second stage heat exchanger are no longer required. This means that the inert gas generation system does not require the provision of ram-air to be supplied to the inter-cooler or post compression cooler, and so the need for multiple hull penetrations, the associated inlets and outlets and ducting is removed, making the arrangement suitable for retro-fitting.

The compressor may be driven by any suitable prime mover such as an electric motor supplied from the aircraft electrical system or by means of a turbine, or by shaft power.

Preferably, the compressor operates with a pressure ratio of between 1.5 and 3.5, and ideally around 2.5, such that the delivery temperature does not exceed the maximum operating temperature of the air separation module.

Preferably, in use, the compressor is operated to deliver compressed air to the ASM at a temperature of in excess of 80° C. and up to 150° C. (300° F.).

One embodiment may include a controller responsive to variation in the temperature of the cabin waste air to adjust at least one of the operating speed and the pressure ratio of the compressor to maintain the compressed air supplied to the air separation module at said predetermined temperature. This embodiment may include a temperature sensor for monitoring the temperature of the cabin waste air, and a controller responsive to said temperature sensor for controlling at least one of the operating speed and the pressure ratio of said compressor to maintain the compressed air supplied to the air separation module at said predetermined temperature.

The onboard inert gas generation system may include means for cooling the NEA fraction; this may comprise a heat exchanger cooled by a suitable coolant, which may for example comprise aircraft fuel or cabin air.

In another embodiment, the present invention provides an onboard inert gas generation system for use on board an aircraft, comprising a compressor configured to receive cabin waste air and to deliver compressed air to an air separation module, and a controller responsive to the temperature of the cabin waste air to adjust at least one of the operating speed and the pressure ratio of said compressor to maintain the compressor air supplied to said air separation module at a predetermined level.

In another embodiment, the invention provides a method of onboard inert gas generation which comprises supplying cabin air to a single-stage compressor, passing compressed air from said compressor to an air separation module, and obtaining from said air separation module an NEA fraction of said compressed air, without active cooling of said compressed air between said compressor and said air separation module.

In yet another embodiment, the invention provides a method of onboard inert gas generation system onboard an aircraft comprises supplying a compressor with cabin waste air, delivering compressed air from said compressor to an air separation module, and controlling the compressor to maintain the compressed air supplied to said air separation module at a predetermined temperature.

Referring to FIG. 2, screened cabin waste air is supplied from the aircraft cabin to a single-stage compressor 10. The single-stage compressor typically receives cabin air at a temperature of up to 24° C. and is capable of operating at a pressure of 2.5 with an isentropic efficiency of 70%. The single-stage compressor delivers compressed air to an air separation module (ASM) 12 at a temperature of up to 150° C. The NEA fraction from the ASM 12 passes via a control valve 14 to the aircraft fuel tank 16. If required, the NEA fraction from the air separation module may be cooled by suitable means shown schematically at 18. For example, it may be cooled by the aircraft fuel using a suitable heat exchanger. The heat transferred from the NEA to the aircraft fuel may be used beneficially to preheat the aircraft fuel as it exits the tank to pass to the aircraft engine. This may improve engine performance and, furthermore, provide anti-icing.

In another embodiment, the NEA may be cooled by a suitable heat exchanger external to the fuel tank with suitable coolant, for example a further portion of cabin air.

The compressor 10 may also include integral cooling as indicated schematically at 8.

A temperature sensor 20 is provided at the compressor inlet and supplies a temperature signal to a controller 22 which controls the speed of the motor 24 driving the compressor, to ensure that the temperature of the fluid leaving the compressor is controlled to a constant level, typically 150° C. In operation, if the cabin air temperature provided to the compressor varies, the compressor speed and consequently its pressure ratio is adjusted by the controller to maintain a substantially constant temperature to the ASM 12. It will be appreciated that an alternative control system will be to detect the temperature at the compressor outlet and to adjust the speed of the motor driving the compressor accordingly.

In the above embodiment, the compressor may be a centrifugal compressor, a rotary positive displacement compressor or any other suitable compressor.

The embodiments described herein provide significant reduction in system costs, weight and space envelope, and also increase system efficiency, reliability and availability.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An onboard inert gas generation system for an aircraft, comprising a compressor configured to receive cabin waste air and to supply compressed air directly to an air separation module such that the compressed air passes from the compressor to the air separation module without active cooling, the air separation module being configured to separate the air into a nitrogen-enriched air fraction and an oxygen-enriched air fraction.

2. The onboard inert gas generation system according to claim 1, wherein the compressor has a housing and a cooling arrangement for the housing.

3. The onboard inert gas generation system according to claim 1, wherein the compressor is configured to operate with a pressure ratio of between 1.5 and 3.5.

4. The onboard inert gas generation system according to claim 3, wherein the compressor is configured to operate with a pressure ratio of about 2.5

5. The onboard inert gas generation system according to claim 1, wherein the compressor is configured to be operated so as to deliver a predetermined level of the compressed air to the air separation module at a predetermined temperature.

6. The onboard inert gas generation system according to claim 5, further comprising a controller responsive to a variation in a temperature of the cabin waste air and configured to adjust at least one of an operating speed and a pressure ratio of the compressor to maintain the compressed air supplied to the air separation module at the predetermined temperature.

7. The outboard inert gas generation system according to claim 6, further comprising a temperature sensor configured to monitor the temperature of the cabin waste air, wherein the controller is responsive to the temperature sensor so as to control the at least one of the operating speed and the pressure ratio of the compressor to maintain the compressed air supplied to the air separation module at the predetermined temperature.

8. The onboard inert gas generation system according to claim 1, further comprising a cooling arrangement configured to cool the nitrogen-enriched air fraction.

9. The onboard inert gas generation system according to claim 8, wherein the cooling arrangement comprises a heat exchanger having a coolant path configured to receive aircraft fuel.

10. The onboard inert gas generation system according to claim 8, wherein the cooling arrangement comprises a heat exchanger having a coolant path configured to receive cabin air.

11. An onboard inert gas generation system for use on board an aircraft, comprising:
a compressor configured to receive cabin waste air and to deliver compressed air to an air separation module; and
a controller responsive to a temperature of the cabin waste air and configured to adjust at least one of the operating speed and the pressure ratio of the compressor so as to maintain the compressor air supplied to the air separation module at a predetermined level.

12. A method of onboard inert gas generation, comprising:
supplying cabin air to a single-stage compressor;
passing compressed air from the compressor to an air separation module; and
obtaining a nitrogen-enriched air fraction of the compressed air from the air separation module,
wherein there is no active cooling of the compressed air between the compressor and the air separation module.

13. A method of onboard inert gas generation system onboard an aircraft, comprising:
supplying a compressor with cabin waste air;
delivering compressed air from the compressor to an air separation module; and
controlling the compressor so as to maintain the compressed air supplied to the air separation module at a predetermined temperature.
